(19) United States
(12) Patent Application Publication
(10) Pub. No.: US 2003/0196500 A1
(43) Pub. Date: Oct. 23, 2003

(54) Starter for a gas engine string trimmer

(76) Inventor: Carl Nauman Jacobson, Franklin, WI (US)

Correspondence Address: Carl Nauman Jacobson, 7719 S. North Cape Rd., Franklin, WI, 53132, US

(21) Appl. No.: 10/132,874

(22) Filed: Apr. 23, 2002

(51) Int. Cl. F02N 1/00

(52) U.S. Cl. 74/6

(57) ABSTRACT

This invention is a rather simple cone shaped cup like device to start gas engine powered string trimmers it is lined with silicone rubber and has a shaft on one end and is powerd by a ⅜ or larger corded reversible drill and the cup fits over the string end of the trimmer the string itself should be no longer than 5 or 6 inches to avoid getting hit by the string when starting the trimmer.

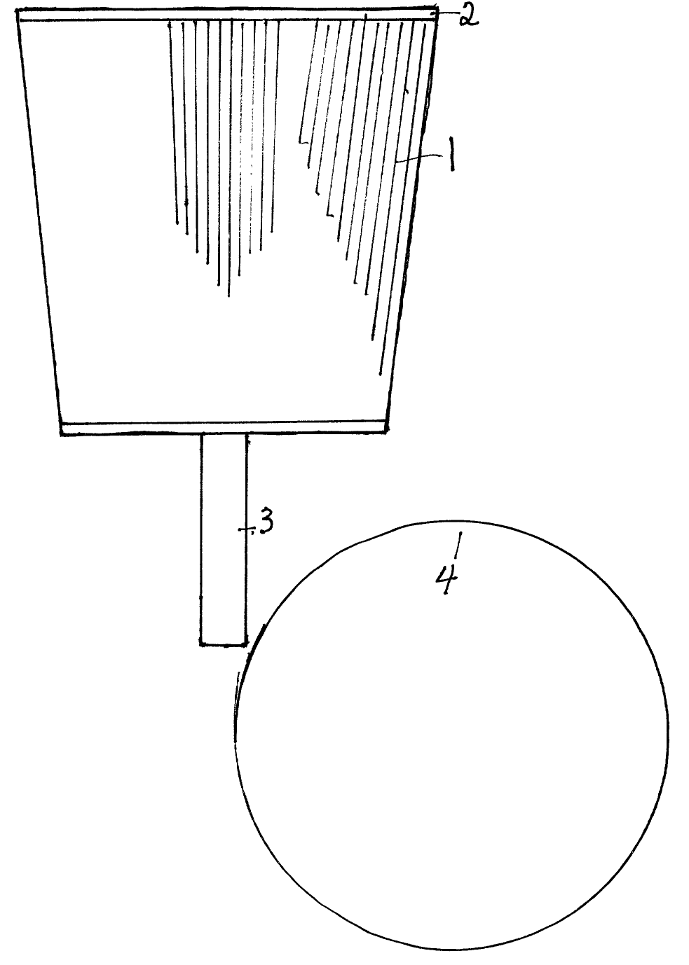

### FIELD OF THE INVENTION

The present invention is for starting string trimmer gas engines without having to pull the the starter rope.

### PRIOR ART

Pulling a rope starter becomes a chore especially when one gets olderand I thought there must be a better way, so I put together a device that that really does the job.

### SUMMARY OF THE INVENTION

The principal purpose of this invention is to provide a means of starting a sting trimmer without pulling a rope starter.

The device can be constructed out of sheet metals or it can be cast out of most any metal, iron, steel bronze or aluminum. It can be die cast out of aluminum or zinc. Though I am not sure that zinc would be strong enough. I think 12 or 14 gauge sheet metal would be the best bet. A straight piece of sheet metal should be cut to the desired length with an extra half inch of metal for overlapping, rolled to size and it can be riveted, welded, soldered or a regular sheet metal lock. The top edge should be rolled to prevent cuts or injury. The bottom will be sturdy steel with a shaft three eights by two and a half inches placed in the exact center. The whole thing shall have a sleight cone shape with the top a little larger than the bottom so that one size will fit all trimmers.

The lenght I estimate should be 5 inches. The reason I can't tell the exact measurements is because I have to get the measures off of gas powered string trimmers which I havet done yet. I was advised to get this idea into you as quickly as possible. I believe this device can be made quite easily and cheaply by a good tinsmith or sheet metal shop. It will be powered by a ⅜ths or larger electric reversible drill. I found that a cordless drill didn't work to good. The string trimmer runs counter clockwise, so the drill has to have a reverse on it.

A flat piece of sheet metal is laid out and cut to width and length and is rolled to a round size. The top is rolled to prevent cuts and injury. A bottom piece is attached and a shaft is placed in the exact center, then a coating of silicone rubber is applied to the inside to contact with the ridge on the string trimmer.

This is the size and shape of the device but the measurements may change a little so it will tit all string trimmers. Maybe it could be used for starting other gas enginesfour cycle.

What is claimed is this is a new and different way to start a gas engine string trimmer.

1. What is claimed is a new method of starting a gas engine powered string trimmer by using a cone-shaped cylindrical device with a silicone rubber lining to contact the ridge on the head of the string trimmer the top has to be rolled to prevent cuts and injury to the operator and the shaft in the bottom has to be precisely located so that the device runs straight so I believe this invention plus the drill to power it is comprising a new method of starting a string trimmer to alleviate the strain of pulling a rope starter
